(19) United States
(12) Patent Application Publication
(10) Pub. No.: US 2005/0279825 A1
(43) Pub. Date: Dec. 22, 2005

(54) Transaction card packaging

(76) Inventors: David A. Ashby, Draper, UT (US); Randall G. Beck, Alpine, UT (US); Andrew R. Plitt, Riverton, UT (US)

Correspondence Address: FITZPATRICK CELLA HARPER & SCINTO, 30 ROCKEFELLER PLAZA, NEW YORK, NY, 10112, US

(21) Appl. No.: 11/043,488

(22) Filed: Jan. 26, 2005

Related U.S. Application Data
(60) Provisional application No. 60/581,553, filed on Jun. 21, 2004.

(51) Int. Cl. G06K 5/00; G06K 7/00

(52) U.S. Cl. 235/380; 235/486

(57) ABSTRACT

A package for preventing forgery and theft of transaction card information. Transaction card information is concealed inside package so as to deter theft and forgery. Retailers can identify security breaches of prepaid transaction cards by observing the condition of the packaging prior to card activation. Consequently, forgery and tempering are deterred as retailers will not activate cards contained in packages that have either been tampered with or damaged.

### CROSS-REFERENCE TO RELATED APPLICATIONS

The present application claims the benefit of U.S. Provisional Application Ser. No. 60/581,553 filed Jun. 21, 2004, the disclosure of which is entirely incorporated herein by reference.

### FIELD OF THE INVENTION

The present invention relates to a package for a transaction card. More specifically, the subject matter relates to a package for packaging prepaid or gift cards to be sold at the retail level and a method of constructing the package.

### BACKGROUND OF THE INVENTION

Prepaid transaction cards are becoming more and more popular with consumers. An example of such a card is the American Express Gift Card. Issuers of prepaid cards would like to sell the cards through retailers to obtain a broad sales base. Due to increased fraud, risk and other security concerns associated with selling prepaid cards through retailers, issuers would like to take as many precautions as possible to prevent the cards from being fraudulently obtained or activated. This is particularly a concern for issuers of open system cards.

It is desirable to provide packaging for such cards that is attractive to customers, easy for a retailer to process and provides security features to deter fraud and theft.

### SUMMARY OF THE INVENTION

The package for a transaction card has a first section, a second section and a third section. Fold lines may be provided between each of the sections to allow the package to be folded around a transaction card. The transaction card may be affixed to the inside of the package.

For example, the transaction card may be affixed to a center panel with a removable adhesive. The package may then be folded around the affixed card, with a right panel being folded over the center panel, and sealing the top and bottom of the right panel to the center panel. A left panel can be folded over the right panel and sealed to the right panel with an adhesive as well. Thus, the entire card, including any magnetic stripe, card number, expiration date and signature panel, are completely enclosed within the package.

An advantage is to provide a package for secure retail sales of prepaid transaction cards.

It is another advantage to provide a package to be displayed on racks or sold from behind service desks at retail stores.

It is an advantage to provide a package whose design deters fraud and theft.

It is an advantage to provide a package enabling retail merchants to track transaction card inventory.

It is yet another advantage to provide a package that is simple, streamlined and easy to carry and/or handle.

It is also an advantage to provide a secure card package that allows card activation at a point of sale.

Additional advantages and novel features of the examples will be set forth in part in the description which follows, and in part will become apparent to those skilled in the art upon examination of the following and the accompanying drawings or may be learned by production or operation of the examples. The advantages may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitation. In the figures, like reference numbers refer to the same or similar elements.

FIG. 1 illustrates the front or outside of one example of a transaction card package.

FIG. 2 illustrates the back or inside of the transaction card package shown in FIG. 1.

FIG. 3 illustrates the front or outside of another example of a transaction card package.

FIG. 4 illustrates the back or inside of the transaction cards package shown in FIG.3.

FIG. 5 illustrates a method for securing a transaction card.

### DETAILED DESCRIPTION

A typical financial transaction card, such as a prepaid or gift card, includes the card issuer's name, a card number and an expiration date embossed onto the card. These features are often located on the front of a card. In addition, the card may include a signature field for the cardholder to provide a signature to protect against forgery and tempering. The signature field is typically located on the back of a card. In addition to the portions described above, a magnetic stripe can be incorporated on the back of the card, thereby allowing data, such as, for example, account information and expiration date, to be stored in machine readable form. As such, magnetic stripe readers, which are associated with a cash register device and connected to a host computer, are used in conjunction with magnetic stripe cards to communicate purchase data, as well as data stored in the magnetic stripe, to the host computer. The gift card may also be activated by using the magnetic stripe, magnetic stripe reader and the host computer.

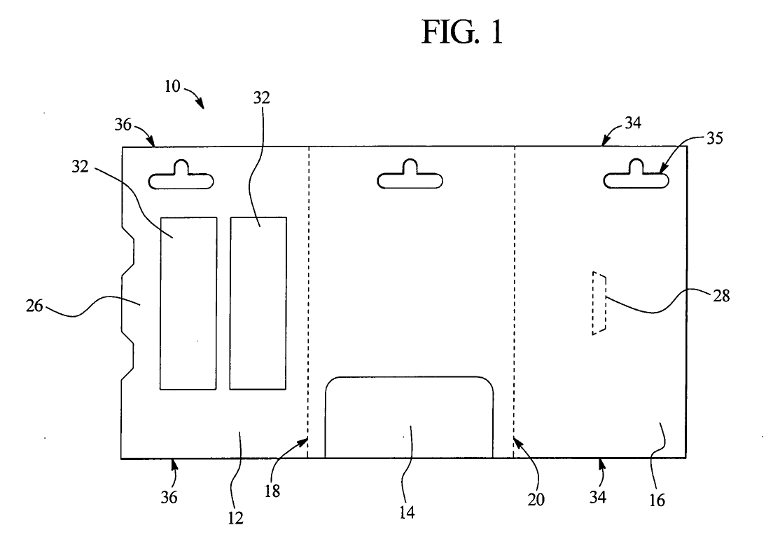

Referring now to FIGS. 1-4, a package 10 for a transaction card is shown. Package 10 has a first section 12, a second section 14 and a third section 16. First section 12, second section 14 and third section 16 are referred to collectively as sections 12, 14 and 16. Sections 12, 14, 16 are shown in FIGS. 1-4 as rectangular panels. However, sections 12, 14, 16 may be panels of another shape. Fold lines 18 and 20 may be provided between each of the sections 12, 14 and 16 to allow package 10 to more easily be folded around the transaction card.

For package 10 shown in FIGS. 1-4, for example, the total length of package 10 may be approximately 9⅞ inches (approximately 25 centimeters). Accordingly, the length of first section 12 may be approximately 3 inches (approximately 7½ centimeters), the length of second section 14 may be approximately 4 inches (approximately 10 centimeters) and the length of third section 16 may be approximately 2⅞ inches (approximately 7⅓ centimeters). The total height of package 10 shown in FIGS. 1-4 may be approximately 5¼ inches (approximately 13⅓ centimeters). These dimensions correspond to the typical transaction card dimensions. Of course, alternatively, other dimensions may be used.

Package 10 shown in FIGS. 1-4 contains a display mechanism 35. In one embodiment, display mechanism 35 may be a cut-out section for hanging package 10, including transaction card, at a retail station. Alternatively, display mechanism 35 can be a separate attachment to package 10 used to display package 10. Alternatively, package 10 may include any other type of display mechanism 35 or none at all.

To enclose a transaction card within package 10, the card may be affixed to the inside of package 10. For example, the card may be affixed to second section 14 with a removable adhesive. Package 10 may then be folded around the affixed card, with third section 16 being folded over second section 14 and top and bottom edges 34 of third section 16 being sealed to second section 14. Then, first section 12 can be folded over third section 16 and the top and bottom edges 36 of first section 12 can be sealed to third section 16. Thus, the entire card, including any magnetic stripe, card number, expiration date and signature panel, is completely enclosed within package 10. Sections 12, 14 and 16 can be sealed with an adhesive or in any other manner. Further, sections 12, 14 and 16 may be sealed at or along other portions of sections 12, 14 and 16.

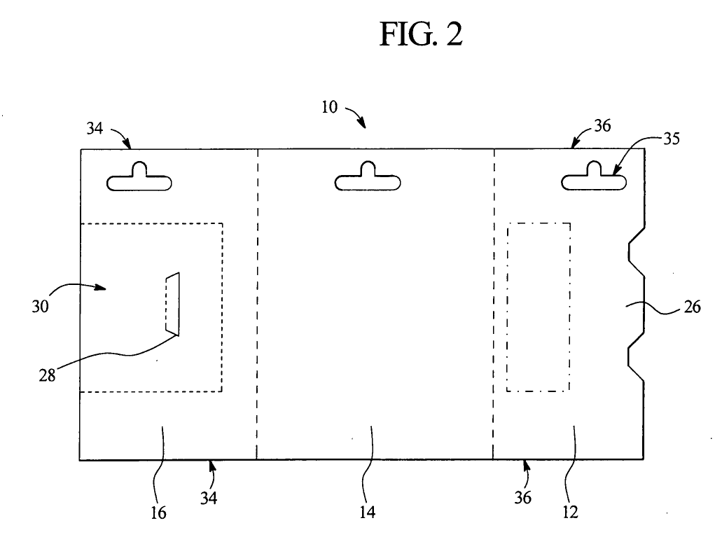

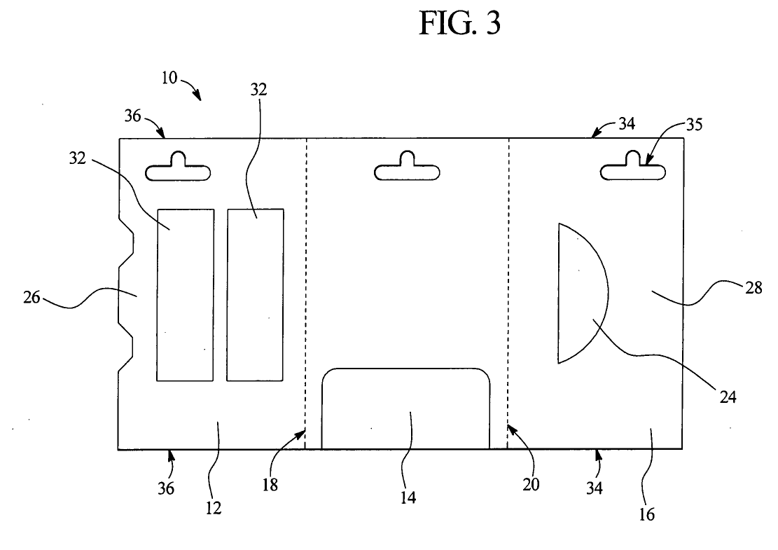

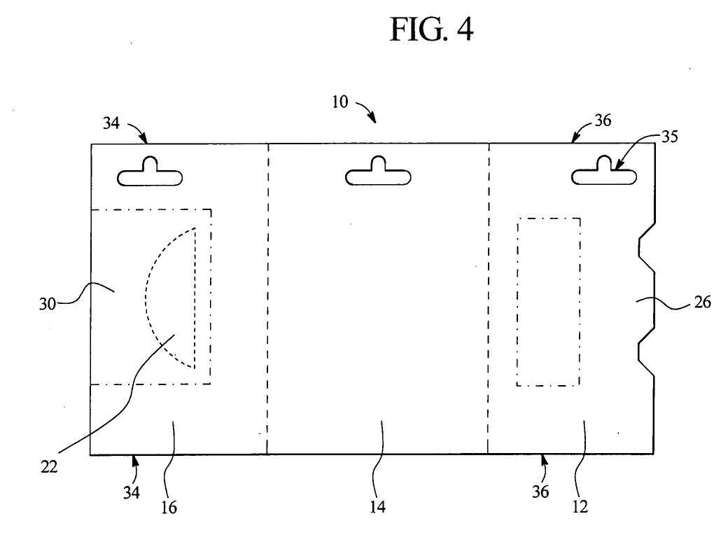

For package 10 shown in FIG. 4, first section 12 is preferably sealed to third section 16 at perforated section 22 such that when package 10 is opened, perforated section 22 is pulled away from package 10 creating a tab mating portion as described further below. Perforated section 22 shown in FIG. 4 is half-moon shaped. However, perforated section 22 may be any shape. Sealed package 10 may be opened by tearing it at the seal between first section 12 and third section 16 to gain access to the card. Doing so with package 10 in the example shown in FIG. 4, causes perforated half-moon shaped section 22 to be removed from third section 16, leaving a half-moon shaped cut-out section 24 as shown in FIG. 3. Cut-out section 24 of FIG. 3 can then be used to reseal package 10 by inserting a tab 26 from first section 12 of package 10 into the tab mating portion, which in this example is cut-out section 24. Perforated section 22 can be perforated around its entire perimeter, or may be perforated only along the arced section and pre-cut along the straight section. Alternately, as shown in FIGS. 1 and 2, tab receiving section 28 can be pre-cut, or partially pre-cut, in third section 16 to function as the tab mating portion. As FIG. 1 shows, tab receiving section 28 is cut along three sides and has a fold line along another side. Tab receiving section 28 shown in FIGS. 1 and 2 mates with tab 26 similarly to cut-out section 24 shown in FIG. 3 and perforated section 22 shown in FIG. 4. Of course other shapes of perforated section 22, cut-out section 24 or tab receiving section 28 may be provided using other combinations of pre-cut sections, perforated sections and fold lines. Moreover, cut-out section 24 and tab receiving section 28 are merely two examples of tab mating portions as contemplated herein.

As shown in FIGS. 1 and 3, package 10 may include machine readable data portions 32 for placing information about the card on package 10. For example, the prepaid amount associated with the card, the card number or any other desired information may be encoded in the information on the outside of package 10, such as within machine readable data portions 32 shown in FIGS. 1 and 3. The card information may be provided using barcodes, or other machine readable encoded data. A barcode placed on package 10 can contain information that can be read by a retailer's point-of-sale (“POS”) system. The encoded data can be a universal product code (“UPC”) symbol, which a retailer can use to cross-reference the retailer's product number with the card. In addition, the encoded data may provide a unique identification number that can be used to activate the card. For example, the unique identification number can be read by the POS system and transmitted to another computer, e.g. a third-party computer. The third-party computer can contain data or a cross-reference table which can be used to look up the card number from the unique identification number. The card number, or other activation information, can then be sent to a card issuer computer, which upon verifying the card number or other information, can activate the card or set the card to an “activateable” state. The card issuer may require that a purchaser take some action (e.g., call the card issuer) to fully activate a card. By placing the card in an “activateable” state, the card issuer is informed that a particular card was actually and/or properly purchased by a purchaser and that the card can be fully activated when the card issuer is contacted by the purchaser. When a card issuer receives the card number or other activation information, the card issuer further informed that the retailer now owes the card issuer money for that particular transaction card.

Alternatively, the unique identification number can be sent directly to the card issuer computer for verification and partial or full activation. Alternately, the card may be fully or partially activated at the retailer by opening package 10 and reading the magnetic stripe on the retailer's card reader system. In order to read the magnetic stripe, the card may be affixed within package 10 so as to require package 10 be partially opened, i.e., unsealing first section 12 from third section 16 to expose a portion of the card's magnetic stripe. With a portion of the magnetic stripe exposed, the magnetic stripe may then be read on the retailer's card reader system. A request can be sent from the retailer's card reader system to the card issuer, either directly or indirectly, requesting that the card issuer either partially or fully activate the card. In this instance, after the card has been activated, package 10 can be resealed as described above with reference to tab 26 and cut-out section 24 or tab receiving section 28. For the purpose of verification and/or activating, the card's magnetic stripe can be coded with the card number. Of course the magnetic stripe on the card can contain other information, such as information needed to make customary transactions using prepaid transaction cards.

If package 10 is opened before it is presented to a retailer for purchase or activation, it may be considered a breach of the card's security, and the retailer can choose not to request activation of that particular card.

Alternatively, card activation can be done or completed by having a purchaser call the card issuer and request activation. Instructions for this process and others processes, e.g. how to report a lost card, may be provided on the card package as well.

In addition, an information attachment 30, such as, for example, a pamphlet may be included in package 10. For example, information attachment 30 may be affixed to package 10 with an adhesive or other means to the inside of third section 16, as shown in FIGS. 2 and 4. Information attachment 30 may contain terms and conditions regarding the use of the card, an advertisement or other information for a card purchaser or user.

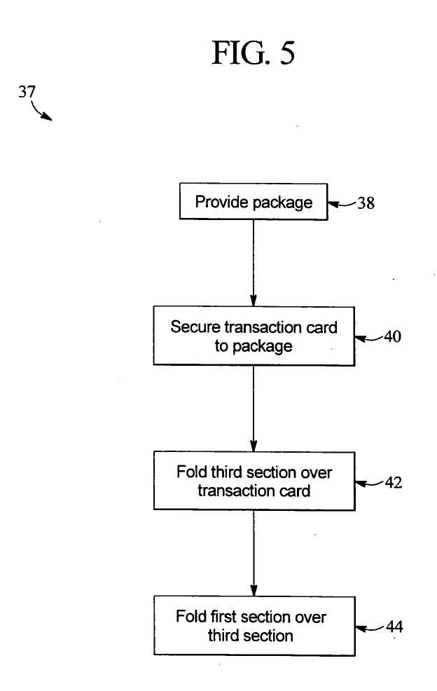

Referring now to FIG. 5, method 37 for securing a transaction card is shown. In step 38, a transaction card package including three sections, such as, for example, package 10 described above with reference to FIGS. 1-4. In step 40, a first side of the transaction card is attached to package 10. For example, as described above, the first side of the transaction card may be secured to second section 14 of package 10. The transaction card may be secured to package 10 using a removable adhesive or any other means of attaching the card may be used. Next, in step 42, third section 16 of package 10 is folded over a second side of the transaction card. Third section 16 may then be attached to second section 14 of package 10. For example, the top and bottom edges of third section 16 may be secured to second section 14. Next, in step 44, third section 16 may be folded over third section 16 of package 10. First section 12 may then be attached to third section 16 and second section 14 of package 10. For example, first section 12 is folded over third section 16 and second section 14, including the transaction card and secured to third section 16 and second section 14 of package 10 with a removable adhesive. In one embodiment, as described above, first section 12 may be secured to third section 16 and second section 14 along top and bottom edges 34 and 36, as shown in FIGS. 1-4.

While the foregoing has described what is considered to be the best mode and/or other examples, it is understood that various modifications may be made therein and that the technology disclosed herein may be implemented in various forms and examples, and that they may be applied in numerous applications, only some of which have been described herein.

1. A transaction card package comprising:
a first panel attached to a second panel along a first fold line, wherein said first panel includes a tab; and
a third panel attached to said second panel along a second fold line, wherein said third panel includes a tab mating portion.

2. The transaction card package of claim 1 wherein said tab mating portion is semi-circular in shape.

3. The transaction card package of claim 1 wherein a transaction card is secured to said second panel.

4. The transaction card package of claim 1 wherein an information attachment is secured to said third panel.

5. The transaction card package of claim 1 wherein the top and bottom edges of said second panel are secured to top and bottom edges of said third panel.

6. The transaction card package of claim 1 wherein the top and bottom edges of said first panel are secured to top and bottom edges of said third panel.

7. The transaction card package of claim 1 wherein said first panel is affixed to said tab mating portion.

8. An apparatus for securing a transaction card comprising:
a second section secured to the transaction card;
a first section secured to said second section; and
a third section secured to said first section and to said second section.

9. The apparatus of claim 8 wherein said first section includes a mating portion for mating with said third section.

10. The apparatus for claim 8 wherein said transaction card is secured to said second section with a removable adhesive.

11. The apparatus of claim 8 wherein the first and second, first and third, and second and third sections are secured to each other using an adhesive.

12. A method for securing a transaction card comprising the steps of:
providing a package comprising a first section attached to a second section along a first fold line and a third section attached to said second section along a second fold line;
securing a first side of the transaction card to said second section;
folding said first section along said first fold line over a second side of the transaction card; and
folding said third section along said second fold line over said first section.

13. The method of claim 12 further including the step of securing the top and bottom edges of said first section to said second section.

14. The method of claim 12 further including the step of securing the top and bottom edges of said second section to said third section.

15. The method of claim 12 further including the step of securing said first section to said third section.
